(19) United States
(12) Patent Application Publication
(10) Pub. No.: US 2022/0048040 A1
(43) Pub. Date: Feb. 17, 2022

(54) Bucket for Collection of Heavy Minerals in Flowing Water

(71) Applicant: Kenneth M. Klyne, Winnipeg (CA)

(72) Inventor: Kenneth M. Klyne, Winnipeg (CA)

(21) Appl. No.: 16/990,399

(22) Filed: Aug. 11, 2020

(51) Int. Cl. B03B 5/58; B03B 11/00

(52) U.S. Cl. CPC B03B 5/58; B03B 11/00

(57) ABSTRACT

A bucket for collection of particulate material in a flowing body of water includes a tubular wall with a closed rear end and an open mouth at a forward end connected to an elongate tether allowing the bucket body to be deposited when empty into a channel in the flowing body of water and to be retrieved from the body of water when filled with particulate material from the channel. A weight bar is mounted internally along the lower face causing the bucket to lie in the channel with the lower face downward. A pipe has an open end adjacent the closed rear end and communicates water to an opening in the upper face for escape allowing more to enter. A movable grate at the open mouth catches stones and can be actuated to discharge the stones.

This invention relates to an apparatus for collection of minerals flowing in a river.

Collection of particulates from a river or stream for panning requires the prospector to dig suitable material from the river bed so that it can be applied to the pan and separated. Some scoops or shovels have been proposed but up to now no dedicated design of bucket has been proposed which allows the prospector to collect material from the best location at the center channel.

### SUMMARY OF THE INVENTION

It is an object of the present invention to provide a bucket for collection of particulate material, potentially containing heavy particles such as gold, flowing in a body of water such as a river or stream.

According to the invention there is provided a bucket for collection of particulate material in a flowing body of water comprising:

a bucket body having one or more walls defining a hollow interior with an open mouth at a forward end and a closed base at an opposed end;

one or more fasteners at the forward end for connection to an elongate tether allowing the bucket body to be deposited when empty into a channel in the flowing body of water and to be retrieved from the body of water when filled with particulate material from the channel;

the bucket body having an upper face along the bucket body for facing upwardly in the body of water and a lower face for facing downwardly toward the bottom of the channel;

a weight member at the lower face which makes the lower face heavier than the upper face to cause the bucket body to lie in the channel with the lower face downward;

one or more openings in said one or more walls allowing escape of water from adjacent the closed base through said one or more openings whereby the water and particulate material in the flowing body of water enters the bucket body through the open mouth for deposit and collection of the particulate materials in the bucket body.

Thus the bucket is held on the tether and is cast into the main water channel in the river to collect the particles flowing along that channel. The weight keeps the bucket in the proper orientation and the openings allow water to escape from the base or rear end toward and through the upper face so that more water and particles can enter until the user perceives or sees the bucket to be filled. It can then be recovered by pulling on the tether to collect the particulates for panning.

In a preferred embodiment the opening or openings is/are located in the upper face to discharge the water away from the lower face sitting on the bottom of the channel.

In a preferred embodiment one opening is attached to a duct or pipe within the bucket body with an open end of the duct or pipe located closer to the closed base than the opening to carry water from the open end of the duct or pipe out of the bucket to prevent the pressure within the bucket from resisting the entrance of the particulate material through the open mouth.

In a preferred embodiment the weight member is located inside the bucket body such as an elongate bar located fastened to the lower face. However the bucket may be fabricated with the weight as an integral portion or the weight may be located on the outer surface.

In a preferred embodiment the bucket body has a lower depending flange at the lower face which extends downwardly and rearwardly from the lower face for engaging into a bottom of the channel in the flowing body. This reduces the tendency of the bucket to flow downstream and thus takes some weight off the tether to aid the user in holding on to the bucket.

In one simple construction, the bucket body is formed from a tube where the closed base is defined by a pinched section closing the upper face downwardly toward the lower face. This pinched section can be used to define the lower flange at the lower face.

In a preferred embodiment, the front face is inclined upwardly and rearwardly from the lower face toward the upper face and preferably there can be provided a grate formed by a series of bars also inclined upwardly and rearwardly at the front face for catching stones. Preferably the grate can be movable by an actuator operable manually by a user holding the tether to discharge or flip the stones upward away from the front face. In this way the presence of larger stones does not prematurely fill up or block up the bucket to the detriment of the collection of the particulates which contain the material to be recovered.

### BRIEF DESCRIPTION OF THE DRAWINGS

One embodiment of the invention will now be described in conjunction with the accompanying drawings in which:

FIG. 1 is a longitudinal cross-sectional view of an apparatus according to the present invention.

FIG. 2 is a cross-sectional view along the lines 2-2 of FIG. 1.

FIG. 3 is a front elevational view of the apparatus of FIG. 1.

FIG. 4 is an isometric view of the apparatus of FIG. 1.

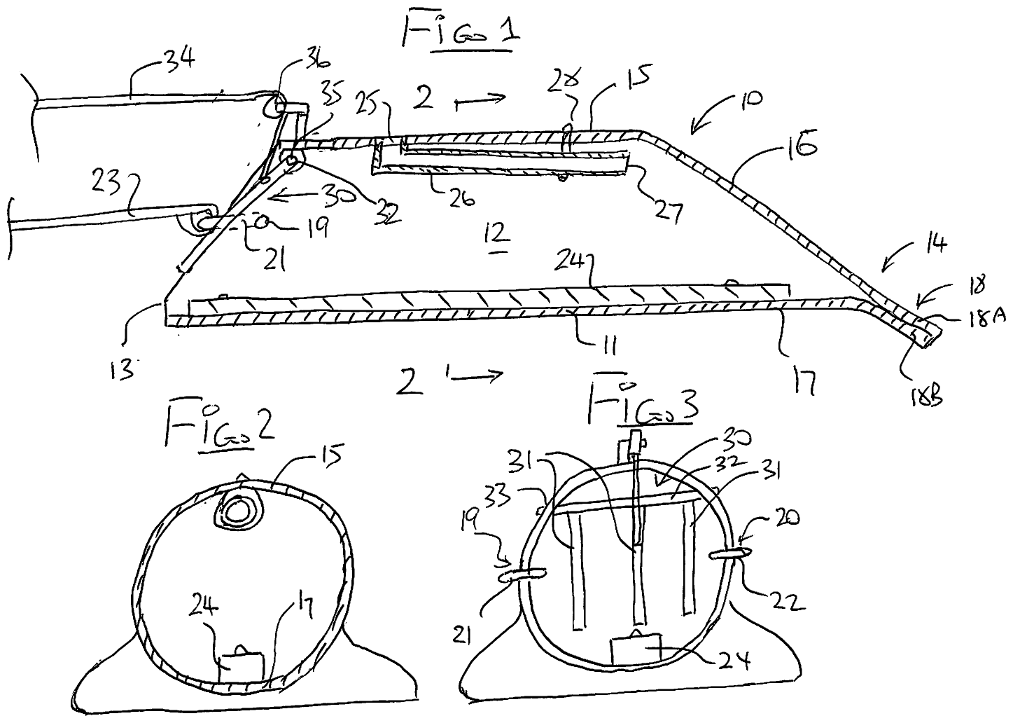

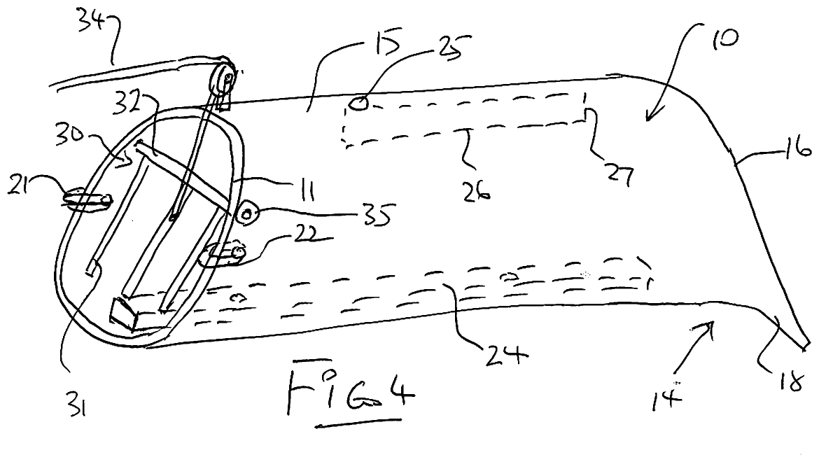

### DETAILED DESCRIPTION

In the figures is shown an apparatus for collection of particulate material in a flowing body of water in the form of a bucket body 10 formed by a tubular wall 11 with a hollow interior 12 for collecting the material. The wall 11 forms a tube with an open mouth 13 at a forward end and a closed base 14 at an opposed end. The closed base is formed by pinching the tube so that an upper face 15 is pressed downwardly toward the lower face 17 as shown at portion 16 to pinch together the wall portions of the tube at the base 14 to form a flange 18 defined by two overlying wall portions 18A and 18B

The tubular wall 11 at the front face is cut at an angle so as to be inclined upwardly and rearwardly from the lower face 17 toward the upper face 15.

The wall 11 has two holes 19, 20 adjacent the front face within a distance or around half an inch and located approximately at one half of the height of the front face to receive fastener rings 21, 22 for connection to connection portions of an elongate tether 23 allowing the bucket body to be deposited when empty into a channel in the flowing body of water and to be retrieved from the body of water when filled with particulate material from the channel.

The bucket body has the upper face 15 along the bucket body for facing upwardly in the body of water and the lower face 17 for facing downwardly toward the bottom of the channel. A weight member in the form of an elongate bar 24 is fastened to the inside surface of the lower face 17. This acts to make the lower face heavier than the upper face to cause the bucket body to lie in the channel with the lower face downward.

The upper face 15 of the wall 11 includes an opening 25 allowing escape of water so that the water and particulate material in the flowing body of water can enter the bucket body through the open mouth for deposit and collection of the particulate materials in the bucket body without the presence of water in the bucket from interfering with the inflow of the material. The opening 25 is located in the upper face and attached to a pipe 26 within the bucket body with an open end 27 of the pipe 26 located closer to the closed base 14 than the opening 25 to carry water from the open end 27 of the pipe out of the bucket body to allow water and particulate material to enter through the open mouth 13.

As an alternative to the opening and pipe, there may be provided a series of openings along the upper surface 14 as a row allowing the release of the water pressure within the bucket and to allow water and particulate material to enter through the open mouth.

As an alternative the weight member can be located outside the bucket body or as part of the body of the wall.

The lower flange 14 at the lower face extends downwardly and rearwardly from the lower face to engage into sand or material at the bottom of the channel to resist the tendency of the bucket to flow down stream.

In order to avoid the bucket being filled with larger material or stones and to collect preferentially the particulates from the channel, there is provided a grate 30 at the front face for catching the stones. The grate 30 includes a plurality of upwardly and rearwardly extending bars 31 generally parallel to the inclined front mouth so as to be inclined upwardly and rearwardly. The bars 31 are attached to a cross rail 32 which is mounted in holes 33 in the wall 11 so that rail 32 and the bars 31 carried thereon can pivot about the axis of the rail to lift the bars. The grate is thus movable to flip up and discharge the stones upward away from the front face. This movement is effected by a suitable actuator operable manually by a user holding the tether. For example the center bar on the grate can be pulled upwardly by a cord 34 passing over a pulley 36 carried on the upper face 15 at the front mouth. The user can thus pull the cord occasionally during filling to dislodge the stones with a spring 35 acting to return the grate to its operating position when released.

1. A bucket for collection of particulate material in a flowing body of water comprising:
a bucket body having one or more walls defining a hollow interior with an open mouth at a forward end and a closed base at an opposed end;
one or more fasteners at the forward end for connection to an elongate tether allowing the bucket body to be deposited when empty into a channel in the flowing body of water and to be retrieved from the body of water when filled with particulate material from the channel;
the bucket body having an upper face along the bucket body for facing upwardly in the body of water and a lower face for facing downwardly toward the bottom of the channel;
a weight member at the lower face which makes the lower face heavier than the upper face to cause the bucket body to lie in the channel with the lower face downward;
one or more openings in said one or more walls allowing escape of water from adjacent the closed base through said one or more openings whereby the water and particulate material in the flowing body of water enters the bucket body through the open mouth for deposit and collection of the particulate materials in the bucket body.

2. The bucket according to claim 1 wherein said one or more openings is located in the upper face.

3. The bucket according to claim 1 wherein said one or more openings comprises an opening which is attached to a duct within the bucket body with an open end of the duct located closer to the closed base than the opening to carry water from the open end of the duct out of the bucket body to allow water and particulate material to enter through the open mouth.

4. The bucket according to claim 1 wherein said one or more openings comprises a single opening which is attached to a pipe within the bucket body with an open end of the pipe located closer to the closed base than the opening to carry water from the open end of the pipe out of the bucket body to allow water and particulate material to enter through the open mouth.

5. The bucket according to claim 1 wherein the weight member is located inside the bucket body.

6. The bucket according to claim 1 wherein the weight member is an elongate bar located inside the bucket body and fastened to the lower face.

7. The bucket according to claim 1 wherein the bucket body has a lower depending flange at the lower face for engaging into a bottom of the channel in the flowing body.

8. The bucket according to claim 1 wherein the lower flange at the lower face extends downwardly and rearwardly from the lower face.

9. The bucket according to claim 1 wherein the bucket body is formed from a tube where the closed base is defined by a pinched section closing the upper face downwardly toward the lower face.

10. The bucket according to claim 9 wherein pinched section defines a lower flange at the lower face which extends downwardly and rearwardly from the lower face for engaging into a bottom of the channel in the flowing body.

11. The bucket according to claim 1 wherein the front face is inclined upwardly and rearwardly from the lower face toward the upper face.

12. The bucket according to claim 1 wherein there is provided a grate at the front face for catching stones.

13. The bucket according to claim 12 wherein the grate is inclined upwardly and rearwardly.

14. The bucket according to claim 12 wherein the grate includes a plurality of upwardly and rearwardly extending bars.

15. The bucket according to claim 12 wherein the grate is movable to discharge the stones upward away from the front face.

16. The bucket according to claim 15 wherein the grate is movable by an actuator operable manually by a user holding the tether.
